(19) United States
(12) Patent Application Publication
(10) Pub. No.: US 2010/0239019 A1
(43) Pub. Date: Sep. 23, 2010

(54) POST PROCESSING OF MOTION VECTORS USING SAD FOR LOW BIT RATE VIDEO COMPRESSION

(76) Inventors: Alois Martin Bock, Hampshire (GB); Satya Ghosh Ammu, Hampshire (GB); Richard May, Hampshire (GB)

Correspondence Address: NIXON & VANDERHYE, PC, 901 NORTH GLEBE ROAD, 11TH FLOOR, ARLINGTON, VA, 22203, US

(21) Appl. No.: 12/663,041

(22) PCT Filed: Jun. 2, 2008
(86) PCT No.: PCT/EP08/56762

§ 371 Date: Jun. 1, 2010

(30) Foreign Application Priority Data
Jun. 6, 2007 (GB) 0710857.4

(51) Int. Cl. H04N 7/32

(52) U.S. Cl. 375/240.16; 375/E07.243

(57) ABSTRACT

A method and system for detecting and replacing spurious motion vectors in video signal compression includes determining whether a motion vector of a current macroblock is spurious by comparing the motion vector with motion vectors of motion vectors of neighbouring macroblocks; and replacing the motion vector as spurious if the difference exceeds a predetermined threshold. In particular, the method and system seeks to determine (72, 73) whether at least one cluster of motion vectors of neighbouring macroblocks can be formed; and if not, leaves (80) the motion vector of the current macroblock unchanged but if so determining (74) whether the motion vector falls within a cluster. The motion vector may be replaced (81) under certain criteria if the motion vector does not fall within a cluster of motion vectors of neighbouring macroblocks.

### TECHNICAL FIELD

This invention relates to post processing of motion vectors for video compression and in particular to cluster-based post processing.

### BACKGROUND

Motion Estimation (ME) and Motion Compensation (MC) are used in video coding to exploit temporal redundancy in a moving image sequence and, hence, to assist in achieving compression for transmission or storage. A number of schemes exist to calculate Motion Vectors (MV) that describe motion in a given image. In real-time embedded systems, block matching ME algorithms are used because of their ease of implementation.

FIG. 1 illustrates a source frame 10 and reference frame 20 used in such an algorithm in which each video image frame is divided into a set of two dimensional square or rectangular groups of contiguous pixels known as macroblocks 11, 21 whose size is typically defined by industry standard coding algorithms. Each complete macroblock 11 is compared pixel by pixel to a selected macroblock-sized area 21 in a reference image frame 20. Such a comparison is conducted systematically over an arbitrarily chosen search area 22 of the reference frame which is appropriately larger than a single macroblock and sufficiently large to contain an expected source image to reference image pixel displacement. A reference macroblock 21 which most closely matches a pixel value distribution of the current source macroblock 11 is selected as the reference block and a two dimensional MV for the current macroblock is expressed as the vertical and horizontal shift 12, 13 respectively in pixels required to translate the current source macroblock 11 to a matching position in the reference frame 20.

Because of its ease of implementation on embedded/DSP platforms, a most popular measure of similarity between current macroblocks and target macroblocks in a reference frame is a Sum of Absolute Differences (SAD) of their respective pixel values. The computation takes each pixel in the current source macroblock 11 and compares it to a pixel in a corresponding position in the reference macroblock 21, taking no account of the sign of the difference value, so that a running sum of moduli of the differences is calculated over the whole macroblock. A reference macroblock 21 within the search area 22 having a least value of this accumulated difference is selected as a best match to the current source macroblock 11. The search is performed over the predetermined search area 22 and using a predefined search pattern. In exhaustive search algorithms, also known as Full Search, the search is performed pixel by pixel on the entire search area 22, and a MV 12, 13, denoting the displacement of the reference macroblock 21 in the reference frame 20 with respect to the source macroblock 11 in the current frame 10 is computed, based on minimal SAD over the whole search. Although SAD is not an exact measure of similarity it provides a good approximation and is readily implemented. Other statistical methods of measuring similarity between macroblocks may also be used but they usually entail additional computational complexity.

Although Full Search algorithms may seem intuitively to provide a best approach to finding a MV, Full Search algorithms often tend to capture sub-optimal MVs. For example, for homogeneous backgrounds of slow or medium motion sequences and in the presence of excessive noise, full search often leads to large MVs partly due to multiple false matches with low SAD values. These spurious MVs are suboptimal as they are optimized based only on similarity and they are not necessarily coherent with MVs in the same neighbourhood. If they do not follow the motion of neighbouring macroblocks, spurious vectors tend to consume more bits in coding the MV differentials, as required in many popular compression algorithms, thus they are sub-optimal in terms of a combined bit rate and similarity measure.

### SUMMARY

It is an object of the present invention at least to ameliorate the aforesaid disadvantages in the prior art.

According to the invention there is provided a method of detecting and replacing spurious motion vectors in a video signal compression process. The method comprises determining whether a motion vector of a current macroblock is spurious by determining whether there is a significant difference between the motion vector and motion vectors of neighbouring macroblocks and replacing the motion vector as spurious with a motion vector derived from neighbouring macroblocks if the difference exceeds a predetermined threshold.

Advantageously, comparing the motion vector with motion vectors of neighbouring macroblocks comprises: seeking to form at least one valid cluster of motion vectors of neighbouring macroblocks; and if at least one valid cluster cannot be formed, leaving the motion vector of the current macroblock unchanged.

Advantageously, seeking to form at least one valid cluster of motion vectors of neighbouring macroblocks comprises determining whether the motion vector of a neighbouring macroblock is a member of a cluster containing a motion vector of a first neighbouring macroblock.

Conveniently, determining whether a motion vector is a member of a cluster containing a first member comprising a motion vector of a first neighbouring macroblock comprises determining whether a Manhattan distance between the motion vector and the motion vector of the first member of the cluster is greater than a first threshold and, if not, including the motion vector in the cluster.

Advantageously, the first threshold is 12 pixels.

Conveniently, determining whether a valid cluster can be formed comprises determining whether a cluster including at least three motion vectors can be formed.

Advantageously, the method further comprises, if at least one valid cluster can be formed: determining whether the motion vector of the current macroblock falls within a valid cluster so formed; and, if so, leaving the motion vector of the current macroblock unchanged.

Conveniently, determining whether the motion vector of the current macroblock falls within a valid cluster comprises determining whether coordinates of the motion vector of the current macroblock fall between minimum and maximum values of coordinates of motion vectors which are members of the cluster.

Advantageously, the method further comprises, if the motion vector of the current macroblock does not fall in a valid cluster, determining which valid cluster comprises a best valid cluster for replacing the current motion vector with a motion vector derived from the motion vector of the best valid cluster by confining search areas to restricted regions associated with each valid cluster and conducting a full search over each such search area, calculating an associated SAD and motion vector to determine which search area has a smaller SAD for the current macroblock to define a refined motion vector for the cluster.

Advantageously, the method further comprises determining whether a difference between the current macroblock motion vector and the refined motion vector derived for a best cluster motion vector exceeds a second threshold; and if not, leaving the motion vector of the current macroblock unchanged.

Advantageously, determining a difference between the motion vector and a best cluster motion vector comprises determining a Manhattan distance between the motion vector and the best cluster motion vector.

Conveniently, the method comprises determining whether a Manhattan distance between the motion vector and a best cluster motion vector exceeds eight pixels.

Advantageously, the method further comprises determining, when the motion vector of the current macroblock does not fall within a cluster, whether a product of a predetermined parameter and the SAD of a current macroblock and a target macroblock located by the motion vector is greater than a SAD of the current macroblock and a target macroblock located by the best cluster motion vector. The predetermined parameter is dependent upon a quantization parameter used to encode the current macroblock. If the product is greater, the motion vector of the current macroblock is replaced by the best cluster motion vector and if not the motion vector of the current macroblock is left unchanged.

Conveniently, the predetermined parameter is defined by the equation:

$$( 1 + \frac{QP - 5}{100} ) best\_MV \_SAD > best\_cluster \_SAD$$

QP is the quantisation parameter, best_MV_SAD is a SAD of a current macroblock and a target macroblock located by the motion vector and best_cluster_SAD is a SAD of the current macroblock and a target macroblock located by a best cluster motion vector.

According to a second aspect of the invention, there is provided a system for detecting and replacing spurious motion vectors in video signal compression. The system comprises: means for determining whether a motion vector of a current macroblock is spurious by determining whether there is a significant difference between the motion vector and motion vectors of neighbouring macroblocks; and means for replacing the motion vector as spurious with a motion vector of a neighbouring macroblock if the difference exceeds a predetermined threshold.

Advantageously, the means for comparing the motion vector with motion vectors of neighbouring macroblocks comprises means for seeking to form at least one valid cluster of motion vectors of neighbouring macroblocks.

Advantageously, the means for seeking to form at least one valid cluster of motion vectors of neighbouring macroblocks comprises means for determining whether a motion vector of a neighbouring macroblock is a member of a cluster containing a motion vector of a first neighbouring macroblock.

Conveniently, the means for determining whether a motion vector is a member of a cluster containing a first member comprising a motion vector of a first neighbouring macroblock comprises means for determining whether a Manhattan distance between the motion vector and a motion vector of the first member of the cluster is greater than a first threshold.

Conveniently, the first threshold is 12 pixels.

Advantageously, a valid cluster comprises at least three motion vectors.

Advantageously, the system further comprises means for determining, if at least one cluster can be formed, whether the motion vector of the current macroblock falls within a valid cluster so formed.

Conveniently, the means for determining whether the motion vector of the current macroblock falls within a valid cluster comprises means for determining whether coordinates of the vector of the current macroblock fall between minimum and maximum values of coordinates of motion vectors which are members of the cluster.

Advantageously, the system further comprises means, if the motion vector of the current macroblock does not fall in a valid cluster, for determining which valid cluster comprises a best valid cluster for replacing the current motion vector with the motion vector derived from the motion vector of a best valid cluster. It is determined which valid cluster motion vector results in a smaller SAD for the current macroblock by restricting a search area associated with each valid cluster and conducting a full search over these areas and calculating an associated SAD and motion vector for the current macroblock to determine which cluster provides a smaller SAD and defining a refined motion vector for that best valid cluster.

Advantageously, the system further comprises means for determining, when at least one cluster can be formed, whether a difference between the current macroblock motion vector and the refined motion vector exceeds a second threshold and if not to leave the current macroblock motion vector unchanged.

Conveniently, the means for determining a difference between the motion vector and the best cluster motion vector comprises means for determining a Manhattan distance between the motion vector and the best cluster motion vector.

Conveniently, the system comprises means for determining whether a Manhattan distance between the motion vector and the best cluster motion vector exceeds eight pixels.

Advantageously, the system further comprises means for determining, when the motion vector of the current macroblock does not fall within a cluster, whether a product of a predetermined parameter and a SAD of a current macroblock and a target macroblock located by the motion vector is greater than a SAD of the current macroblock and a target macroblock represented by a best cluster motion vector. The predetermined parameter is dependent upon a quantization parameter used to encode the current macroblock. Means are provided for replacing the motion vector of the current macroblock if so by the best cluster motion vector and if not leaving the motion vector of the current macroblock unchanged.

Conveniently, the predetermined parameter is defined by the equation:

$$( 1 + \frac{QP - 5}{100} ) best\_MV \_SAD > best\_cluster \_SAD$$

where QP is the quantisation parameter, best_MV_SAD is the SAD of a current macroblock and a target macroblock located by the motion vector and best_cluster_SAD is the SAD of the current macroblock and a target macroblock represented by a best cluster motion vector.

The object is achieved by the independent claims. The dependent claims relate to further embodiments.

### BRIEF DESCRIPTION OF THE DRAWINGS

The invention will now be described, by way of example, with reference to the accompanying drawings in which:

FIG. 1 is a schematic drawing of a source frame and a reference frame illustrating known motion vector (MV) derivation in a block matching process for motion estimation (ME), useful in understanding the present invention;

FIG. 2 is a schematic diagram of neighbouring macroblocks, with associated motion vectors, surrounding a current macroblock X, used in the invention;

FIG. 3 is a flowchart of the clustering process of the invention;

FIG. 4 is a flowchart of a refined search process around a restricted area associated with a valid cluster area of the invention;

FIG. 5 is a schematic diagram of a current MV within a restricted area associated with a cluster of the invention;

FIG. 6 is a schematic diagram of a current MV outside a restricted area associated with a cluster of the invention;

FIG. 7 shows extension of the cluster area of FIG. 6 to define the new full search area associated with each valid cluster;

FIG. 8 is a flowchart of a method according to the invention; and

FIG. 9 is a vector diagram illustrating a known calculation of a Manhattan distance between vectors, useful in the present invention.

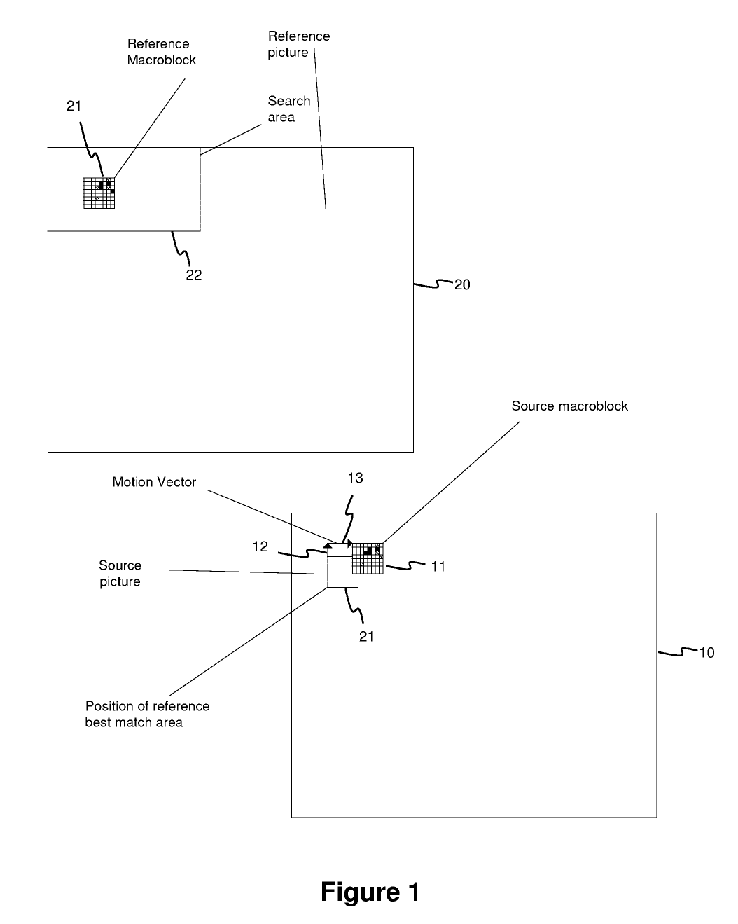

In the Figures, like reference numbers denote like parts.

### DETAILED DESCRIPTION

### Cluster-Based Post-Processing of MVs

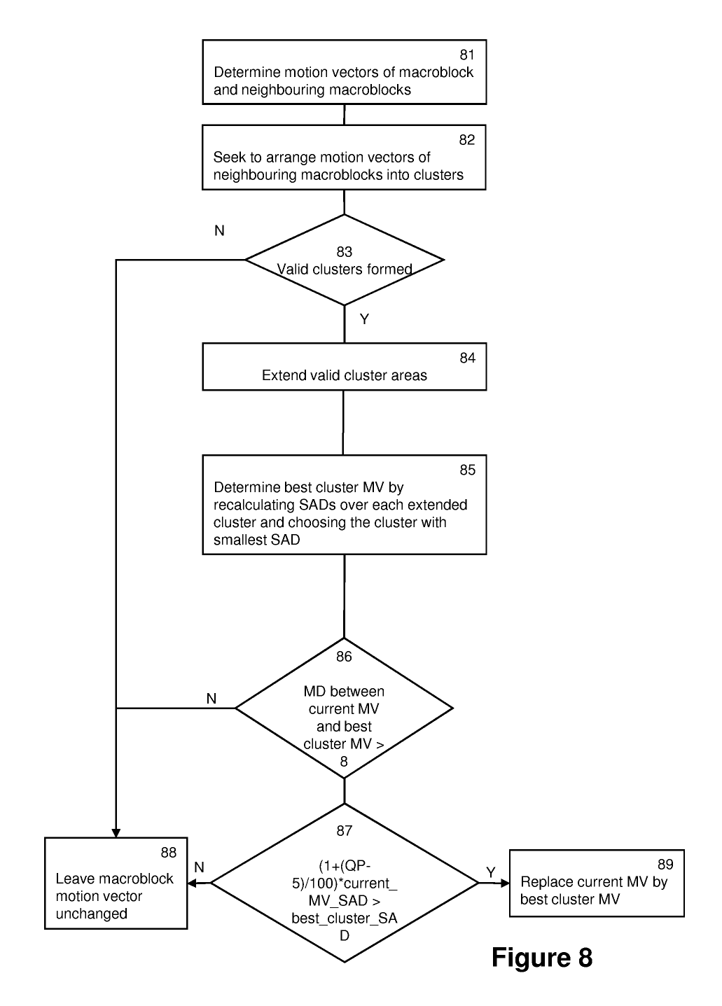

Referring to FIG. 8, cluster-based post-processing of MVs according to the invention comprises determining, steps 82-83, whether a motion vector of a macroblock being post-processed belongs to a cluster of motion vectors of neighbouring macroblocks and if not replacing, step 89, the motion vector subject to certain conditions. The method includes the following steps.

1) Formation, step 82, 83 of clusters of motion vectors of neighbouring macroblocks;

2) Refinement, step 84-85, of the motion vectors; and

3) Decision logic, steps 86-87, to determine whether to replace the motion vector.

### Formation of Clusters

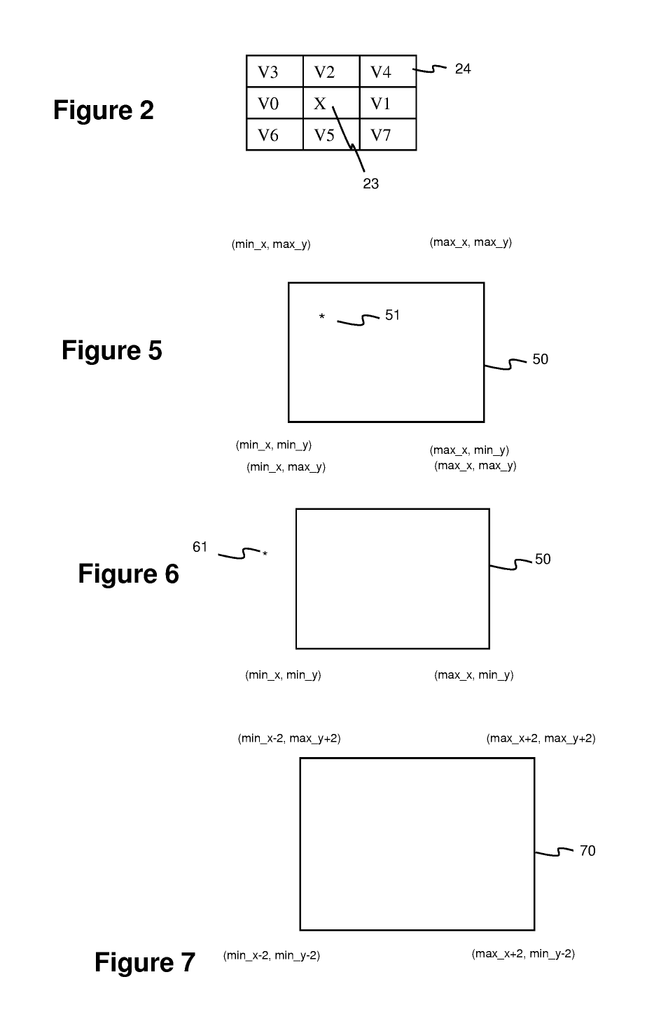

A preliminary step is therefore, after determining, step 81, motion vectors of a macroblock and of neighbouring macroblocks, to form, step 82, motion vectors of macroblocks neighbouring a currently post-processed macroblock into clusters of motion vectors. Referring to FIG. 2, a cluster is defined as a group of similar motion vectors defining macroblocks 24 neighbouring a given macroblock 23 currently being post-processed. The cluster can comprise motion vectors V0 . . . V7 of any number of neighbouring macroblocks and the set of neighbouring macroblocks 24 may dynamically take on different shapes depending upon actual motion in an image at this position. In practice a compromise between hardware complexity and cost and performance improvement suggests that acceptable results can be achieved by considering only the eight nearest macroblocks 24, as shown in FIG. 2.

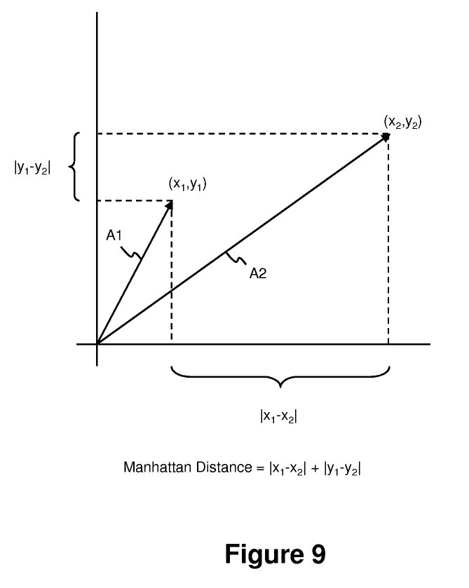

Referring to FIG. 9, a known Manhattan distance (MD) is defined for two vectors A1(x₁, y₁) and A2(x₂, y₂) as abs(x₁-x₂)+abs(y₁-y₂). The motion vectors (V0 . . . V7) of the eight nearest neighbourhood macroblocks 24 surrounding the current macroblock X, as illustrated by FIG. 2, are analysed and grouped into clusters based on their Manhattan distances.

Referring to FIGS. 5 to 7, clustering is based on a modified hierarchical clustering algorithm and initially motion vectors of all eight neighbouring macroblocks are considered as forming eight independent clusters each comprising a single vector. Parameters min_x and max_x are used to indicate minimum and maximum values of the horizontal component of clustered motion vectors, and parameters min_y and max_y are used to indicate the minimum and maximum values of the vertical component of the clustered motion vectors. In general, i.e. for clusters containing more than one motion vector, these parameters indicate the range of motion in horizontal and vertical directions of the cluster, as shown in FIGS. 5 and 6.

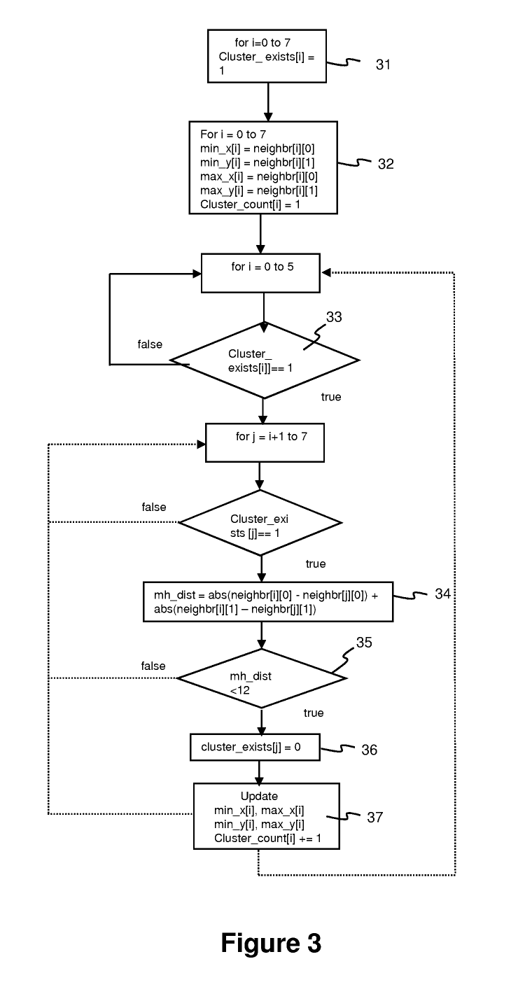

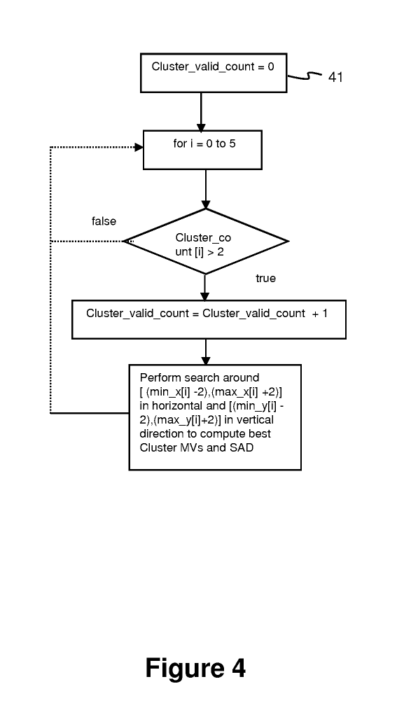

Referring to the flowcharts of FIGS. 3 and 4, parameters “Cluster_count”, indicating a number of motion vectors included in a cluster, and “Cluster_valid_count”, indicating the number of clusters that have three or more motion vectors included, are defined to facilitate the calculations. A “Cluster_exists” flag is associated with each cluster, where, for example, a value of ‘0’ indicates a non-existent cluster and ‘1’ represents a cluster that exists, that is it includes at least three independent vectors, and this flag and the value of “Cluster_count” are initialized, steps 31, 32, with value 1 for each of the eight initial single vector clusters. In practice, taking a valid cluster to be a cluster which contains motion vectors of at least three macroblocks has been found to preferable. Initially, treating the motion vector of each neighbouring macroblock as a cluster containing a single vector, for each of these eight single-vector clusters, parameters min_x, min_y, max_x and max_y are initialized, step 32, to values of the single motion vector of each neighbouring macroblock.

Step 33 determines whether a given macroblock has already been taken into a cluster and if so terminates the test and moves on to the next macroblock otherwise it is subjected to the examination process of steps 34-37.

Referring to FIGS. 2 and 3, starting with candidate vector V0 of a first neighbouring macroblock 24, a Manhattan distance is computed, step 34, between motion vector V0 and each of motion vectors V1 to V7 of the remaining macroblocks 24 immediately neighbouring the current macroblock 23 with motion vector X. It is determined, step 35, whether any of these motion vectors has a Manhattan distance less than a predetermined Manhattan distance, from the motion vector V0 and if so the motion vector is considered as part of cluster having the cluster motion vector V0 and the motion vector is merged with the cluster; the values of min_x, max_x, min_y and max_y for the merged cluster originally having only vector V0 are updated by taking the greatest and smallest component values from the clustered vectors. A value of 12 pixels for the predetermined Manhattan distance has been found to be suitable by experimentation, using various values of a quantization parameter, to be large enough to ensure that valid clusters can be formed but small enough that not all motion vectors of a neighbouring macroblocks always fall within a same cluster. “Cluster_count” is incremented, step 37, by 1 each time a vector is captured by the cluster containing V0 and the “Cluster_exists” flag of the corresponding merged vector is set, step 36, to zero. This process is repeated to determine whether each of vectors V0 to vector V7 may be placed in an existing cluster.

The process of FIG. 3 precedes that of FIG. 4 wherein the value of “Cluster_valid_count” is initialised to 0 at step 41. The subsequent steps produce the best cluster motion vector and SAD of those available.

Referring again to FIG. 8, at the end of this process some of the initial eight vectors will have merged to form, step 82, clusters of vectors representing macroblocks that have similar motion, referred to herein as the cluster motion vector. After processing, “Cluster_count” indicates the number of vectors that form a cluster and the “Cluster_exists” flag indicates whether the cluster under consideration exists, i.e. is not merged with another cluster. Ideally, only one cluster of vectors from all the neighbouring macroblocks remains but the production of spurious vector values during the preceding Full Search may occasionally lead to more than one surviving. Furthermore, if motion at a position in the image represented by the macroblock is split into more than one direction, for example if the neighbouring macroblocks include an edge of a moving object, thus including both foreground and background image pixels, then there is genuine reason for more than one cluster of motion vectors to exist. The question to resolve therefore is: with which, if any, of these clusters should the MV of the current macroblock X be associated? The choice among candidates is made by the process of FIG. 4.

### Step 2: Refinement

As indicated above, a cluster is considered to be valid if it has vectors of three or more macroblocks. If there are no valid clusters, that is, if there is no close Manhattan distance between any vectors, the process will terminate leaving, step 88, the original current macroblock MV unmodified as macroblock X in FIG. 2. As eight neighbourhood elements are considered, a maximum two valid clusters containing vectors from at least three macroblocks are possible.

If the current motion vector 51 for macroblock X in FIG. 2 falls into any of the valid cluster areas 50, as shown in FIG. 5, the process shown in FIG. 8 is terminated, step 88, and the motion vector for macroblock X is left unmodified.

So that current macroblock motion vectors, 61, which fall just outside the valid cluster area, 50, shown in FIG. 6 are not unnecessarily changed, each valid cluster area is extended, 70, by a small amount, as shown in FIG. 7, where the small amount is shown as an additional 4 pixels in the x and y directions, and a full search made over this restricted area to calculate a new refined SAD and associated motion vector for the current macroblock for each valid cluster.

After such a restricted area search is used a determination is first made to which valid cluster of motion vectors to consider correcting the motion of the current macroblock. This is determined, step 85, by comparing the new refined SAD values for each valid cluster and selecting as a candidate for the current macroblock that motion vector which is associated with the smaller of these SADs. The lower value of the two SADs determines which of the two valid clusters is selected to provide an alternative candidate to the original MV and is defined as the “best cluster MV”. These SAD values may be greater than the original MV SAD for the current macroblock but may be preferable in being associated with vectors close to those within the valid clusters.

Step 3: Decision logic

In this final step a decision is made whether or not to replace, step 89, the original MV with a refined MV. The original MV is replaced with the best cluster MV if both the following conditions are satisfied:
1) It is determined, step 86, whether the Manhattan distance between the current MV and the best cluster MV is greater than 8.
2) It is determined, step 87, whether the SADs of the best cluster MV and the SAD of the current MV are related as below.

(1+(QP−5)/100)*current_SAD>best_cluster_SAD

where

QP=Estimate of the quantisation parameter for the current macro block

current_SAD=SAD corresponding to the MV of the current macro block

best_cluster_SAD=the lowest of two SADs corresponding to the two extended area candidate clusters.

This QP-based threshold ensures that at higher QPs there is more bias towards cluster motion vectors compared with macroblocks quantised at lower QPs.

Thus, there has been described a cluster-based post processor algorithm of MVs to correct any spurious sub-optimal ME. A full search ME is followed by a cluster-based post-processor algorithm that improves the performance of exhaustive ME. Basically, a normal full search ME is carried out and in addition MVs are computed which are optimized in terms of their neighbourhood similarity. Cluster-based post processing analyses MVs of each macroblock together with the surrounding neighbourhood macroblock MVs to help identify possible spurious vectors and hence leads to a correction of the sub-optimal MVs and thus optimises the MVs in terms of rate and similarity. Thus the proposed ME of full search followed by cluster based post-processing of MVs gives a good approximation of rate distortion optimised MVs. As the post-processing algorithm is applied only when suspected spurious sub-optimum MVs are detected, the average computational requirements of the post-processor are very low.

There has been described a process comprising three steps.

### Step 1: Formation of Clusters:

Firstly all 8 neighbourhood macroblock motion vectors, shown in FIG. 2, are considered as 8 independent clusters.
Starting with V0, the Manhattan distance between V0 and each of the other clusters V1, V2 . . . V7 is calculated. If the Manhattan distance between V0 and any of the other clusters is less than or equal to 12 the two clusters are merged and considered as a single cluster. For example if the distance between V0 and V1 is 8 then V1 will be made part of cluster V0 and V1 ceases to exist as an independent motion vector and becomes a member of the cluster with a motion vector V0. A cluster is defined to be valid only if it has at least 3 elements.
For example let V0 be a valid cluster containing V0, V1, V3 and V5. In this example V1 and V3 and V5 are part of V0 and so they are all ignored when seeking to form a second cluster. Clustering continues for V2 with V4, V6, V7. If this succeeds in merging V2 with V4 and V6 then there will be no clustering based on V3, V4, V5 or V6 as the first member so the process will next try to cluster V7 which will be left alone and as such is invalid as a cluster.
After this clustering of neighbouring macroblocks the valid clusters, of which up to a maximum of two are possible, are counted and if there are none the process terminates.
If there are valid clusters each is compared to the motion vector of the current macroblock to establish whether the current MV is part of any of these valid clusters. The current MV is defined as the MV that the motion estimation process has associated with macroblock X in FIG. 2. If the current MV is part of a valid cluster, the process is terminated and if the current MV is not part of a valid cluster, then the following Refinement process is applied.

### Step 2: Refinement

This process identifies the best Cluster MV of the valid clusters by determining which valid cluster has the smaller SAD value after conducting a full search over a restricted area around each valid cluster to determine a new refined SAD and a motion vector. The motion vector of this valid cluster is the best valid cluster candidate for replacing the motion vector of the current macroblock. Once the best Cluster MV is found the following decision logic is applied.

### Step 3: Decision Logic

If the current MV for macroblock X of FIG. 2 is within a Manhattan distance of 8 pixels from the best Cluster MV the process is terminated. If not the following test is applied:
If current MV SAD*(QP based threshold)>Best Cluster MV SAD

then the current MV for macroblock X is replaced with the best Cluster MV.

1.-30. (canceled)

31. A method of detecting and replacing spurious motion vectors in a video signal compression process, the method comprising:
a. determining whether a motion vector of a current macroblock is spurious by determining whether there is a significant difference between the motion vector and motion vectors of neighbouring macroblocks; and
b. replacing the motion vector as spurious with a motion vector derived from neighbouring macroblocks if the difference exceeds a predetermined threshold.

32. A method as claimed in claim 31, wherein comparing the motion vector with motion vectors of neighbouring macroblocks comprises:
a, seeking to form at least one valid cluster of motion vectors of neighbouring macroblocks; and
b. if at least one valid cluster cannot be formed, leaving the motion vector of the current macroblock unchanged.

33. A method as claimed in claim 32, wherein seeking to form at least one valid cluster of motion vectors of neighbouring macroblocks comprises determining whether the motion vector of a neighbouring macroblock is a member of a cluster containing a motion vector of a first neighbouring macroblock.

34. A method as claimed in claim 33, wherein determining whether a motion vector is a member of a cluster containing a first member comprising a motion vector of a first neighbouring macroblock comprises determining whether a Manhattan distance between the motion vector and a motion vector of the first member of the cluster is greater than a first threshold, and if not including the motion vector in the cluster.

35. A method as claimed in claim 34, wherein determining whether a valid cluster can be formed comprises determining whether a cluster including at least three motion vectors can be formed.

36. A method as claimed in claim 34, comprising, if at least one valid cluster can be formed:
a. determining whether the motion vector of the current macroblock falls within a valid cluster so formed; and
b. if so leaving the motion vector of the current macroblock unchanged.

37. A method as claimed in claim 35, wherein determining whether the motion vector of the current macroblock falls within a valid cluster comprises determining whether coordinates of the motion vector of the current macroblock fall between minimum and maximum values of coordinates of motion vectors which are members of the cluster.

38. A method as claimed in claim 37, further comprising, if the motion vector of the current macroblock does not fall in a valid cluster, determining which valid cluster comprises a best valid cluster for replacing the current motion vector with a motion vector derived from the motion vector of the best valid cluster by confining search areas to restricted regions associated with each valid cluster and conducting a full search over each such search area, calculating an associated SAD and motion vector to determine which search area has a smaller SAD for the current macroblock to define a refined motion vector for the cluster.

39. A method as claimed in claim 38, further comprising:
a. determining whether a difference between the current macroblock motion vector and the refined motion vector derived for a best cluster motion vector exceeds a second threshold; and
b. if not, leaving the motion vector of the current macroblock unchanged.

40. A method as claimed in claim 39, comprising determining whether a Manhattan distance between the motion vector and a best cluster motion vector exceeds eight pixels.

41. A method as claimed in claim 40 further comprising determining, when the motion vector of the current macroblock does not fall within a cluster, whether a product of a predetermined parameter and the SAD of a current macroblock and a target macroblock located by the motion vector is greater than a SAD of a the current macroblock and a target macroblock located by the best cluster motion vector, wherein the predetermined parameter is dependent upon a quantization parameter used to encode the current macroblock; and, if so, replacing the motion vector of the current macroblock by the best cluster motion vector and if not leaving the motion vector of the current macroblock unchanged.

42. A method as claimed in claim 41 wherein the predetermined parameter is defined by the equation:
$$( 1 + \frac{QP - 5}{100} ) best\_MV \_SAD > best\_cluster \_SAD$$
where QP is the quantisation parameter, best_MV_SAD is a SAD of a current macroblock and a target macroblock located by the motion vector and best_cluster_SAD is a SAD of the current macroblock and a target macroblock located by a best cluster motion vector.

43. A system for detecting and replacing spurious motion vectors in video signal compression comprising:
a. means for determining whether a motion vector of a current macroblock is spurious by determining whether there is a significant difference between the motion vector and motion vectors of neighbouring macroblocks; and
b. means for replacing the motion vector as spurious with a motion vector of a neighbouring macroblock if the difference exceeds a predetermined threshold.

44. A system as claimed in claim 43, wherein the means for comparing the motion vector with motion vectors of neighbouring macroblocks comprises means for seeking to form at least one valid cluster of motion vectors of neighbouring macroblocks.

45. A system as claimed in claim 44, wherein the means for seeking to form at least one valid cluster of motion vectors of neighbouring macroblocks comprises means for determining whether a motion vector of a neighbouring macroblock is a member of a cluster containing a motion vector of a first neighbouring macroblock.

46. A system as claimed in claim 45, wherein the means for determining whether a motion vector is a member of a cluster containing a first member comprising a motion vector of a first neighbouring macroblock comprises means for determining whether a Manhattan distance between the motion vector and the motion vector of the first member of the cluster is greater than a first threshold.

47. A system as claimed in claim 46, wherein the first threshold is 12 pixels.

48. A system as claimed in claim 47, wherein the means for determining whether the motion vector of the current macroblock falls within a valid cluster comprises means for determining whether coordinates of the vector of the current macroblock fall between minimum and maximum values of coordinates of motion vectors which are members of the cluster.

49. A system as claimed in claim 48, further comprising means, if the motion vector of the current macroblock does not fall in a valid cluster, for determining which valid cluster comprises a best valid cluster for replacing the current motion vector with the motion vector derived from the motion vector of the best valid cluster by determining which valid cluster motion vector results in a smaller SAD for the current macroblock by restricting a search area associated with each valid cluster and conducting a full search over these areas and calculating an associated SAD and motion vector for the current macroblock to determine which cluster provides a smaller SAD and defining a refined motion vector for that best valid cluster.

50. A system as claimed in claim 49, further comprising means for determining, when at least one cluster can be formed, whether a difference between the current motion macroblock motion vector and the refined motion vector exceeds a second threshold, and if not, to leave the current macroblock motion vector unchanged; wherein the means for determining a difference between the motion vector and the best cluster motion vector comprises means for determining a Manhattan distance between the motion vector and the best cluster motion vector; comprising means for determining whether a Manhattan distance between the motion vector and the best cluster motion vector exceeds eight pixels.
